(19) United States
(12) Patent Application Publication
(10) Pub. No.: US 2019/0326676 A1
(43) Pub. Date: Oct. 24, 2019

(54) HIGH-FREQUENCY APPARATUS

(71) Applicant: SHARP KABUSHIKI KAISHA, Sakai City (JP)

(72) Inventor: EIJI SUEMATSU, Sakai City (JP)

(21) Appl. No.: 16/388,249

(22) Filed: Apr. 18, 2019

(30) Foreign Application Priority Data
Apr. 23, 2018 (JP) 2018-082439

(51) Int. Cl. H01Q 9/04; H01Q 15/02; H01Q 19/06; H01Q 1/38; H01Q 21/06; H01Q 3/24

(52) U.S. Cl. CPC H01Q 9/0485; H01Q 15/02; H01Q 3/24; H01Q 1/38; H01Q 21/061; H01Q 19/06

(57) ABSTRACT

A high-frequency apparatus includes a circuit substrate, a planar antenna unit, a high-frequency circuit unit, and a dielectric block that is provided with an accommodation chamber for accommodating the circuit substrate. The circuit substrate includes a first main surface and a second main surface. The planar antenna unit is provided on the first main surface. The high-frequency circuit unit is provided on the first main surface and is connected to the planar antenna unit. The accommodation chamber includes a first inner surface portion that is in contact with the second main surface and to which the circuit substrate is fixed and a second inner surface portion that opposes the planar antenna unit with a space therebetween.

### BACKGROUND

### 1. Field

The present disclosure relates to a high-frequency apparatus.

### 2. Description of the Related Art

Japanese Unexamined Patent Application Publication No. 2010-141566 discloses a dielectric-loaded antenna which is a high-frequency apparatus of the related art. The dielectric-loaded antenna described in Japanese Unexamined Patent Application Publication No. 2010-141566 includes a substrate constituting a patch antenna and a dielectric block to be disposed on the substrate so as to cover a radio wave radiation portion on the substrate.

The substrate includes a pair of dielectric layers laminated with a ground conductor interposed therebetween, a radiation patch which is a radiation portion of radio waves is formed on the surface of one of the dielectric layers, and a power supply line for supplying power to the radiation patch is formed on the surface of the other of the dielectric layers.

The outer shape of the dielectric block is formed in a columnar shape, and the circular bottom surface is formed to have a size enough to cover the whole of the radiation patch. On the bottom surface of the dielectric block, when attached to the substrate, a concave portion for forming a hollow portion together with the substrate is formed.

The concave portion has a shape obtained by cutting out a cylindrical portion concentric with the dielectric block from the dielectric block, and the inner diameter thereof is formed to have such a size that at least the radiation patch to be disposed in the hollow portion does not come into contact with the dielectric block.

Each of the outer size (height T, diameter φ) of the dielectric block and the size (height Th, diameter (inner diameter) φh) of the hollow portion formed by the concave portion is set so as to obtain a desired directivity according to a dielectric constant (relative dielectric constant) εr of the dielectric block.

However, when assembling the high-frequency apparatus having the above-described structure to a device, it is necessary to integrate the dielectric block and the substrate while aligning the dielectric block and the substrate. In order to integrate the dielectric block and the substrate while aligning the dielectric block and the substrate, a supporting base such as a holder that supports the dielectric block and the substrate is required. Since the supporting base has a three-dimensional structure and has a complicated shape, the outer size of the high-frequency apparatus provided with the supporting base is increased. Also, when the high-frequency apparatus is assembled to the device, there is a problem that insertion work, attachment work, or installation work of the high-frequency apparatus into a casing becomes complicated. Further, in order to improve the mass productivity of the high-frequency apparatus, it is necessary to enable production of the supporting base by using a metal mold. For this reason, there is a problem that the development cost of the high-frequency apparatus increases and the high-frequency apparatus becomes expensive.

It is desirable to provide a compact and inexpensive high-frequency apparatus that may be easily assembled.

### SUMMARY

According to an aspect of the disclosure, there is provided a high-frequency apparatus including a circuit substrate, a planar antenna unit, a high-frequency circuit unit, and a dielectric block that is provided with an accommodation chamber for accommodating the circuit substrate. The circuit substrate includes a first main surface and a second main surface. The planar antenna unit is provided on the first main surface. The high-frequency circuit unit is provided on the first main surface and is connected to the planar antenna unit. The accommodation chamber includes a first inner surface portion that is in contact with the second main surface and to which the circuit substrate is fixed, and a second inner surface portion that opposes the planar antenna unit with a space therebetween. The dielectric block includes a first dielectric portion that is located on a side of the second inner surface portion opposite to a side of the accommodation chamber, and a second dielectric portion that is located on the side of the accommodation chamber of the second inner surface portion. The first dielectric portion has a columnar outer shape. When the operating wavelength of the planar antenna unit is λ, a dimension of the maximum width of the first dielectric portion in the section substantially parallel to the first main surface is λ or more.

### BRIEF DESCRIPTION OF THE DRAWINGS

FIG. 1 is a sectional view showing a configuration of a high-frequency apparatus according to Embodiment 1 of the present disclosure;

FIG. 2 is a sectional view of the high-frequency apparatus of FIG. 1, as viewed from the direction of the arrow II-II;

FIG. 3 is an enlarged sectional view of the high-frequency apparatus of FIG. 2, as viewed from the direction of the arrow III-III;

FIG. 4 is a schematic view showing paths of radio waves passing through a dielectric block in the high-frequency apparatus according to Embodiment 1 of the present disclosure;

FIG. 5 is a block view showing a circuit configuration of the high-frequency apparatus according to Embodiment 1 of the present disclosure;

FIG. 6 is a sectional view showing a configuration of a high-frequency apparatus according to a first modification example of Embodiment 1 of the present disclosure;

FIG. 7 is a sectional view of the high-frequency apparatus of FIG. 6, as viewed from a direction of the arrow VII-VII;

FIG. 8 is a sectional view showing a configuration of a high-frequency apparatus according to a second modification example of Embodiment 1 of the present disclosure;

FIG. 9 is a sectional view of the high-frequency apparatus of FIG. 8, as viewed from the direction of the arrow IX-IX;

FIG. 10 is an enlarged sectional view of a part of the high-frequency apparatus of FIG. 9, as viewed from the direction of the arrow X-X;

FIG. 11 is a sectional view showing a configuration of a high-frequency apparatus according to Embodiment 2 of the present disclosure;

FIG. 12 is a schematic view showing paths of radio waves transmitting through a side surface of the dielectric block included in the high-frequency apparatus according to Embodiment 1 of the present disclosure;

FIG. 13 is a schematic view showing paths of radio waves that are totally reflected by a side surface of a dielectric block included in the high-frequency apparatus according to Embodiment 2 of the present disclosure;

FIG. 14 is a sectional view showing a circuit configuration of a high-frequency apparatus according to Embodiment 3 of the present disclosure;

FIG. 15 is a sectional view of the high-frequency apparatus of FIG. 14, as viewed in the direction of the arrow XV-XV;

FIG. 16 is a block view showing a configuration of the high-frequency apparatus according to Embodiment 3 of the present disclosure; and

FIG. 17 is a schematic view showing a closed space in which an apparatus including a plurality of high-frequency apparatuses according to Embodiment 4 of the present disclosure is installed.

### DESCRIPTION OF THE EMBODIMENTS

Hereinafter, a high-frequency apparatus according to each embodiment of the present disclosure will be described with reference to the drawings. In the following description of the embodiments, the same or corresponding parts in the drawing are denoted by the same reference numerals, and the description thereof will not be repeated.

### Embodiment 1

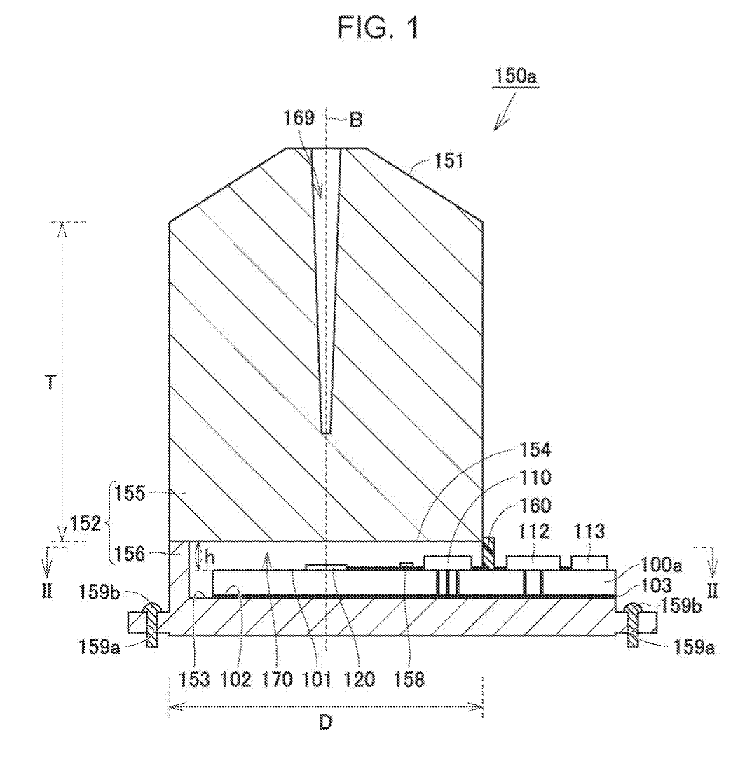

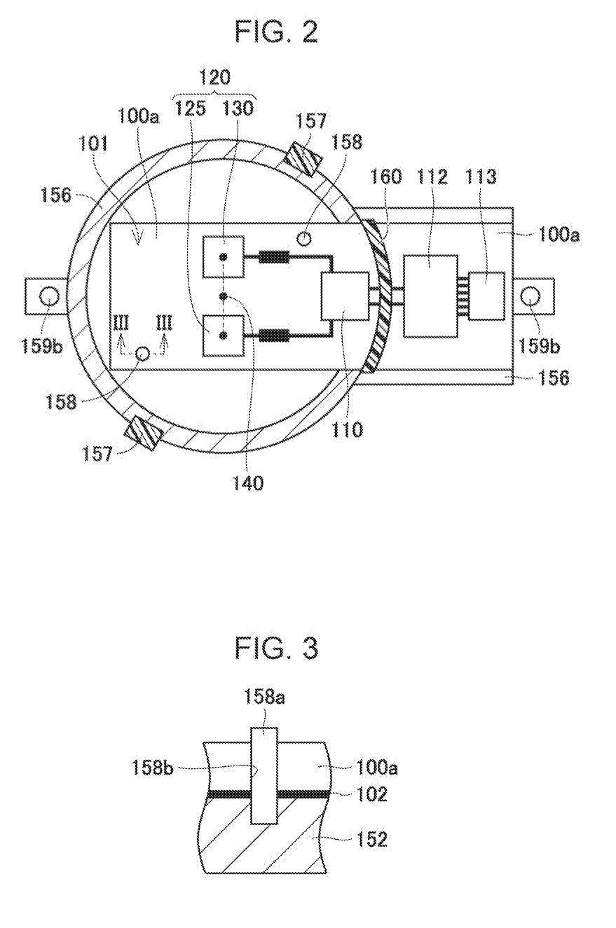

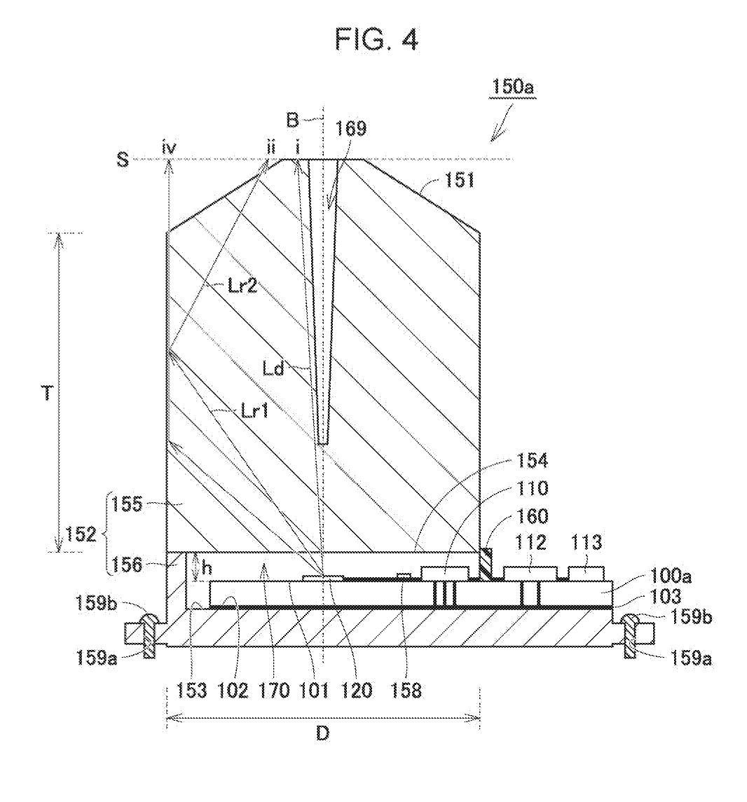

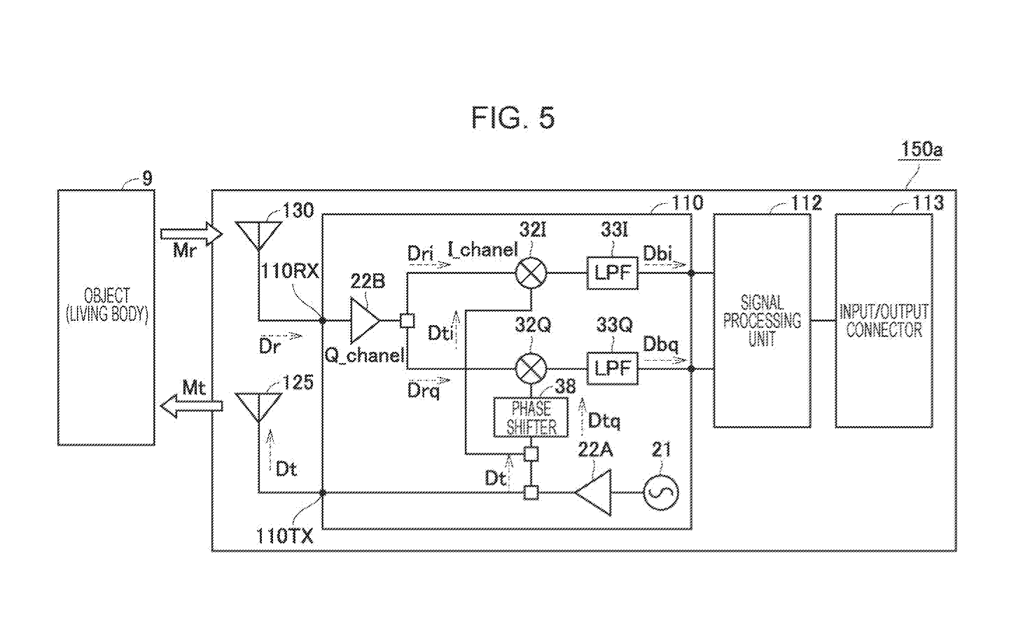

FIG. 1 is a sectional view showing a configuration of a high-frequency apparatus according to Embodiment 1 of the present disclosure. FIG. 2 is a sectional view of the high-frequency apparatus of FIG. 1, as viewed from the direction of the arrow II-II. FIG. 3 is an enlarged sectional view of the high-frequency apparatus of FIG. 2, as viewed from the direction of the arrow III-III. FIG. 4 is a schematic view showing paths of radio waves passing through a dielectric block in the high-frequency apparatus according to Embodiment 1 of the present disclosure. FIG. 5 is a block view showing a circuit configuration of the high-frequency apparatus according to Embodiment 1 of the present disclosure.

As shown in FIGS. 1 to 3, a high-frequency apparatus 150a according to Embodiment 1 of the present disclosure includes a circuit substrate 100a, a planar antenna unit 120, a high-frequency circuit unit 110, a dielectric block 152, a signal processing unit 112, and an input/output connector 113.

The circuit substrate 100a includes a first main surface 101 and a second main surface 102. In the present embodiment, the size of each of the first main surface 101 and the second main surface 102 is 15 mm×50 mm, and the thickness of the circuit substrate 100a is 0.5 mm.

The second main surface 102 includes a ground conductor 103, and a partial region of the first main surface 101 is electrically connected to the ground conductor 103 by a through-hole conductor. A partial region of the second main surface 102 is configured by rear surface wiring of the signal processing unit 112. The rear surface wiring is not shown.

The planar antenna unit 120 is provided on the first main surface 101. As shown in FIG. 2, the planar antenna unit 120 according to the present embodiment includes a transmit antenna unit 125 and a receive antenna unit 130. Each of the transmit antenna unit 125 and the receive antenna unit 130 is a microstrip patch antenna formed of a patch conductor.

The high-frequency circuit unit 110 is provided on the first main surface 101 and is connected to the planar antenna unit 120. In the present embodiment, the high-frequency circuit unit 110 is a microwave circuit unit, and the high-frequency circuit unit 110 is configured by circuit wiring by a microstrip line. The circuit configuration of the high-frequency circuit unit 110 will be described later.

As shown in FIG. 1, the dielectric block 152 is configured as a lid body in the high-frequency apparatus 150a. In the present embodiment, a dielectric antenna includes the planar antenna unit 120 having the transmit antenna unit 125 and the receive antenna unit 130, and the dielectric block 152.

The dielectric block 152 is provided with an accommodation chamber 170 that accommodates the circuit substrate 100a. The accommodation chamber 170 includes an opening on the side surface of the dielectric block 152. The circuit substrate 100a is inserted into the accommodation chamber 170 from the opening.

As shown in FIG. 1, the accommodation chamber 170 includes a first inner surface portion 153 that is in contact with the second main surface 102 and to which the circuit substrate 100a is fixed and a second inner surface portion 154 that opposes the planar antenna unit 120 with a space therebetween.

In the present embodiment, when viewed from the vertical direction of the first main surface 101, the outer shape of a second inner surface portion 154 is, for example, a substantially circular shape having a diameter of 36 mm, and a first inner surface portion 153 and a second inner surface portion 154 oppose each other by 2.5 mm, for example.

As shown in FIGS. 2 and 3, in the present embodiment, the circuit substrate 100a is fixed to the dielectric block 152 by two fitting and fixing portions 158. As shown in FIG. 3, in the fitting and fixing portion 158, a hole portion 158b is provided in the circuit substrate 100a, and a protrusion 158a is provided on a second dielectric portion 156. By fitting the protrusion 158a into the hole portion 158b, the circuit substrate 100a is fixed to the dielectric block 152.

Assuming that the operating wavelength of the planar antenna unit 120 is ?, in a state where the circuit substrate 100a is fixed to the dielectric block 152, the shortest distance between the second inner surface portion 154 and the planar antenna unit 120 is 1 mm or more and λ/2or less. In the present embodiment, the second inner surface portion 154 is a plane substantially parallel to the first main surface 101 of the circuit substrate 100a.

The dielectric block 152 is made of a dielectric material and is made of polypropylene, for example.

The dielectric block 152 includes a first dielectric portion 155 that is located on the side opposite to the accommodation chamber 170 with respect to the second inner surface portion 154 and a second dielectric portion 156 that is located on the accommodation chamber 170 side with respect to the second inner surface portion 154.

In the present embodiment, in order to ensure mass productivity, the first dielectric portion 155 and the second dielectric portion 156 are each configured as separate components from each other, and the first dielectric portion 155 and the second dielectric portion 156 are connected to each other by a connecting portion 157.

The first dielectric portion 155 and the second dielectric portion 156 do not have to be configured as separate components from each other, and the first dielectric portion 155 and the second dielectric portion 156 may be defined by cutting a single dielectric material to form the accommodation chamber 170.

The connecting portion 157 is a screw or a pin made of, for example, a resin material, and the first dielectric portion 155 and the second dielectric portion 156 are connected to each other and integrated by the connecting portion 157. In a case where the connecting portion 157 is a screw, for example, the first dielectric portion 155 and the second dielectric portion 156 are connected to each other by providing a through hole through which a screw is inserted in the first dielectric portion 155, providing a female screw in the second dielectric portion 156, and screwing the screw inserted through the through hole of the first dielectric portion 155 into the female screw on the second dielectric portion 156. In a case where the connecting portion 157 is a pin, for example, the first dielectric portion 155 and the second dielectric portion 156 are connected to each other by providing each of the first dielectric portion 155 and the second dielectric portion 156 with a hole portion to be fitted with the pin and fitting the pin into the hole portions of the first dielectric portion 155 and the second dielectric portion 156.

The first dielectric portion 155 and the second dielectric portion 156 may be integrated by being fitted to each other or may be integrated with each other by an adhesive or the like. In this case, the fitting portion of each of the first dielectric portion 155 and the second dielectric portion 156 or the adhesive corresponds to the connecting portion.

As shown in FIG. 1, the first dielectric portion 155 has a columnar outer shape. In the present embodiment, the first dielectric portion 155 has a substantially columnar outer shape, but the first dielectric portion 155 may have a substantially prismatic outer shape or a substantially polygonal prismatic outer shape.

The first dielectric portion 155 has a frustum-shaped portion 151 on the side opposite to the accommodation chamber 170 side. In the present embodiment, the frustum-shaped portion 151 has a truncated cone shape, but in a case where the first dielectric portion has a substantially prismatic outer shape, the frustum-shaped portion 151 is a truncated pyramidal shape. In addition, the first dielectric portion 155 may have a spherical portion instead of the frustum-shaped portion on the side opposite to the accommodation chamber 170 side.

As shown in FIG. 1, the distance from the second inner surface portion 154 to the end surface of the frustum-shaped portion 151 on the accommodation chamber 170 side is set as a basic height T. In the present embodiment, the basic height T is, for example, 40 mm.

As shown in FIG. 1, the first dielectric portion 155 may have a bubble removing portion 169 formed of an elongated hollow hole on a central axis B. In a case where the first dielectric portion 155 having a thickness of 2 cm or more is formed by pouring a resin into a metal mold, if the bubble removing portion 169 is formed in the first dielectric portion 155, a nonuniform portion of the cooling rate of the resin hardly occurs. In addition, in order to make it difficult for the nonuniform portion of the cooling rate of the resin to occur, the dielectric block may be formed by dividing into a plurality of times.

The central portion of the planar antenna unit 120 is located on the central axis B of the first dielectric portion 155. In the present embodiment, as shown in FIG. 2, the central portion of the planar antenna unit 120 is a midpoint 140 of the line segment connecting the central portions of the transmit antenna unit 125 and the receive antenna unit 130.

That is, as shown in FIGS. 1 and 2, the midpoint 140 between the transmit antenna unit 125 and the receive antenna unit 130 is located on the central axis B of the dielectric block 152. By aligning the dielectric block 152 and the planar antenna unit 120 in the line of the axis in this manner, the azimuth angle direction and the elevation angle direction of the axis in the front direction of the radiation beam of the dielectric antenna may be more aligned with the front direction.

In the present embodiment, both of the transmit antenna unit 125 and the receive antenna unit 130 are disposed in the accommodation chamber 170 of one dielectric block 152. With this single dielectric block 152, the transmit antenna gain and the receive antenna gain may be increased.

Assuming that the operating wavelength of the planar antenna unit 120 is λ as described above, in the present embodiment, a dimension D of the maximum width of the first dielectric portion 155 in the section substantially parallel to the first main surface 101 is λ or more. The dimension D is preferably about 2λ or more and about 4λ or less, and the dimension D in the present embodiment is about 3λ. For example, in a case where the operating frequency is in a 24 GHz band, the operating wavelength λ is 12.5 mm, 3λ is 37.5 mm, and D is 40 mm.

In the present embodiment, a ratio (T/D) of the basic height T and the dimension D is configured to be 1 or more.

In the case where the first dielectric portion 155 has a substantially columnar outer shape, the dimension D corresponds to the diameter of the first dielectric portion 155 in the substantially circular section substantially parallel to the first main surface 101. In addition, in a case where the first dielectric portion 155 has a substantially prismatic outer shape, the dimension D corresponds to the length of the diagonal line of the first dielectric portion 155 in the rectangular section substantially parallel to the first main surface 101.

The second dielectric portion 156 has the first inner surface portion 153. In the present embodiment, the distance between the end surface of the second dielectric portion 156 on the side opposite to the first dielectric portion 155 side and the first inner surface portion 153 is set to 5 mm as an example.

At least two screw holes 159a are formed in the second dielectric portion 156. The high-frequency apparatus 150a according to the present embodiment is attached to the casing of a facility device in which the high-frequency apparatus 150a is used, by a screw 159b.

As shown in FIGS. 1 and 2, the high-frequency apparatus 150a according to the present embodiment may further include a lid portion 160 that seals the accommodation chamber 170. The lid portion 160 is made of a resin.

In the present embodiment, as shown in FIGS. 1 and 2, the signal processing unit 112 is provided on the first main surface 101 of the circuit substrate 100a, but may be provided on a substrate different from the circuit substrate 100a.

The signal processing unit 112 is electrically connected to the high-frequency circuit unit 110. In the present embodiment, the signal processing unit 112 includes an analog amplifying portion including an operational amplifier (not shown), an analog filter circuit, and a microcomputer unit for digital signal processing.

As shown in FIGS. 1 and 2, the input/output connector 113 is provided on the first main surface 101 and is electrically connected to the signal processing unit 112.

In the present embodiment, the circuit substrate 100a on which respective components are mounted is inserted into the accommodation chamber 170 of the dielectric block 152, but since the signal processing unit 112 is provided on the circuit substrate 100a, it is impossible to accommodate all of the circuit substrate 100a in the accommodation chamber 170, and a part of the circuit substrate 100a is disposed outside the dielectric block 152. However, as shown in FIGS. 1 and 2, the second dielectric portion 156 of the dielectric block 152 has a structure extending in the side surface direction of the dielectric block 152 so as to support the circuit substrate 100a even outside the accommodation chamber 170.

Hereinafter, radio waves radiated from the dielectric antenna will be described with reference to FIG. 4. The planar antenna unit 120 has a radiation surface on the side of the first dielectric portion 155, and radio waves are radiated from the radiation surface. In order to allow radio waves radiated from the radiation surface of the planar antenna unit 120 to efficiently transmit through the first dielectric portion 155, impedance matching is achieved by providing a gap h between the first main surface 101 and the second inner surface portion 154 in the accommodation chamber 170. Assuming that the operating wavelength is 2, the length of the gap h is about λ/8 to λ/4, and in the present embodiment, λ=12.5 mm, and therefore the gap h is about 2 mm.

Radio waves passing through the first dielectric portion 155 are broadly divided into the following five kinds of radio waves. A first radio wave is a radio wave that travels through the inside of the first dielectric portion 155, which is a radio wave i which directly reaches a plane S parallel to the front-end surface of the first dielectric portion 155 without being reflected. A second radio wave is a radio wave that travels through the inside of the first dielectric portion 155, which is a radio wave ii that is reflected once by the side surface of the first dielectric portion 155 and reaches the plane S. A third radio wave is a radio wave that travels through the inside of the first dielectric portion 155, which is a radio wave iii that is reflected a plurality of times by the side surface of the first dielectric portion 155 and reaches the plane S. A fourth radio wave is a radio wave iv that reaches the plane S as a surface wave travelling along the side surface of the first dielectric portion 155. A fifth radio wave is a radio wave v transmitting through the side surface of the first dielectric portion 155.

Among the above five types of radio waves, the radio waves having the possibility of having the same phase on the plane S are three types of radio waves, radio wave i, radio wave ii, and radio wave iv. FIG. 4 shows the paths of these three types of radio waves. Whether or not these three types of radio waves are in phase on the plane S largely depends on the shape of the first dielectric portion 155.

In order for the distances until reaching the respective planes S of the radio wave i and the radio wave ii to become equal, as shown in FIG. 4, from the viewpoint of the physical path length, the above ratio (T/D) is 1 or more, preferably as large as possible. On the other hand, in order to prevent the radio wave iii from occurring, it is necessary to set the ratio (T/D) to 1 or less. However, as described below, the allowable ratio (T/D) is practically about 1 to 1.3.

For example, in a case where the dielectric block 152 is made of polypropylene, the relative dielectric constant of the dielectric block 152 is about 2.3 and is substantially uniform within the first dielectric portion 155. However, the substantial dielectric constant that determines the phase velocity of the radio wave appears smaller as the radio wave is closer to the side surface of the first dielectric portion 155, and appears larger as the radio wave is closer to the central axis of the first dielectric portion 155. Therefore, the phase velocity of the radio wave inside the first dielectric portion 155 is faster as the radio wave is closer to the side surface of the first dielectric portion 155, and becomes slower as the radio wave is closer to the central axis of the first dielectric portion 155.

That is, as shown in FIG. 4, the length of a path Lr1+a path Lr2 of the radio wave ii reflected by the side surface of the dielectric appears to be longer than the length of a path Ld of the radio wave i, but from the viewpoint of the phase velocity, the electrical length of the path Lr1+the path Lr2 appears to be substantially shortened. Considering this shortening, in order to make the appearance ratio (T/D) to 1 or less, the allowable ratio (T/D) is practically about 1 to 1.3.

In addition, in the present embodiment, since the first dielectric portion 155 has the frustum-shaped portion 151 on the side opposite to the accommodation chamber 170 side, the radio wave i, the radio wave ii, and the radio wave iv are easily aligned in phase on the plane S, and the radio waves radiated from the tip direction of the high-frequency apparatus 150a may be approximated to plane waves.

Hereinafter, with reference to FIG. 5, the circuit configuration and operation of the high-frequency apparatus 150a according to the present embodiment will be described.

The high-frequency apparatus 150a according to the present embodiment constitutes a microwave Doppler sensor, and as shown in FIG. 5, microwaves are radiated to a subject which is an object 9 such as a living body and the reflected microwaves are processed by the signal processing unit 112 as signals reflecting the movement of the body of the subject. In addition, the high-frequency apparatus 150a generates an I channel signal and a Q channel signal that are orthogonal to each other from the reflected signals that have processed the input reflected waves.

Specifically, the high-frequency circuit unit 110 includes an oscillation circuit 21, amplifiers 22A and 22B, mixers 321 and 32Q, low-pass filters (LPF) 331 and 33Q, and a 90-degree phase shifter 38. As shown in FIG. 5, the high-frequency circuit unit 110 in the present embodiment is integrated as a monolithic microwave integrated circuit (MMIC), but the high-frequency circuit unit 110 may include individual components such as a high-frequency transistor and a diode.

The microwave sinusoidal signal output from the oscillation circuit 21 is amplified by the amplifier 22A and radiated from the transmit antenna unit 125. A microwave Mt radiated into the space is reflected by the object, for example, the body surface of the subject such as the chest of the living body. In the reflected microwave Mr, a Doppler frequency and a phase corresponding to the movement of the body, breathing, and heartbeat of the subject are generated. Therefore, the reflected signal of the microwave Mr to be input to the receive antenna unit 130 is a signal corresponding to the body motion, breathing, and heartbeat of the subject.

The reflected signal received by the receive antenna unit 130 is amplified by the amplifier 22B. An amplified reception signal Dr is input to each of the I channel side mixer 321 and the Q channel side mixer 32Q. Here, the reception signal Dr to be input to the I channel side is referred to as “Dri” for convenience, and the reception signal Dr input to the Q channel side is referred to as “Drq” for convenience.

A transmission signal Dt amplified by the amplifier 22A is input to the mixer 321 on the I channel side and the mixer 32Q via the 90-degree phase shifter 38. Here, the transmission signal Dt to be input to the I channel side is referred to as “Dti” for convenience, and the transmission signal Dt to be input to the Q channel side is referred to as “Dtq” for convenience. In the present embodiment, a configuration is described in which the phase of a transmission signal Dtq with respect to a transmission signal Dti is shifted by 90 degrees by using the 90-degree phase shifter 38, but the configuration is not limited to this configuration. For example, the phase of the reception signal Drq with respect to the reception signal Dri may be shifted by 90 degrees by using the 90-degree phase shifter 38 on the input side of the mixer 32Q.

The signal subjected to the frequency conversion, specifically, the down-conversion by the mixer 321 is input to the LPF 331. The LPF 331 outputs a signal, from which relatively high-frequency components have been removed, to the signal processing unit 112 as a baseband signal Dbi on the I channel side. In addition, the signal subjected to the frequency conversion by the mixer 32Q is input to the LPF 33Q. The LPF 33Q outputs a signal from which relatively high-frequency components have been removed from the signal to the signal processing unit 112 as a baseband signal Dbq on the Q channel side. The baseband signals Dbi and Dbq are output as signals including the Doppler frequency and the phase, respectively, according to the body motion of the subject.

The speed and the amplitude of the reflection signal to be input to the receive antenna unit 130 change with time. Therefore, while the signal on the I channel side and the signal on the Q channel side momentarily differ in phase by 90 degrees, the phase advance of the baseband signal Dbq with respect to the baseband signal Dbi is not constant but always varies with time depending on the signal transmission speed and the transmission direction.

Here, a modification example of Embodiment 1 of the present disclosure will be described. In a first modification example of Embodiment 1 of the present disclosure, since the outer shape of the circuit substrate of the high-frequency apparatus 150a is different from the outer shape of the circuit substrate 100a in Embodiment 1, the description of the same configuration as that of the high-frequency apparatus 150a according to Embodiment 1 will not be repeated.

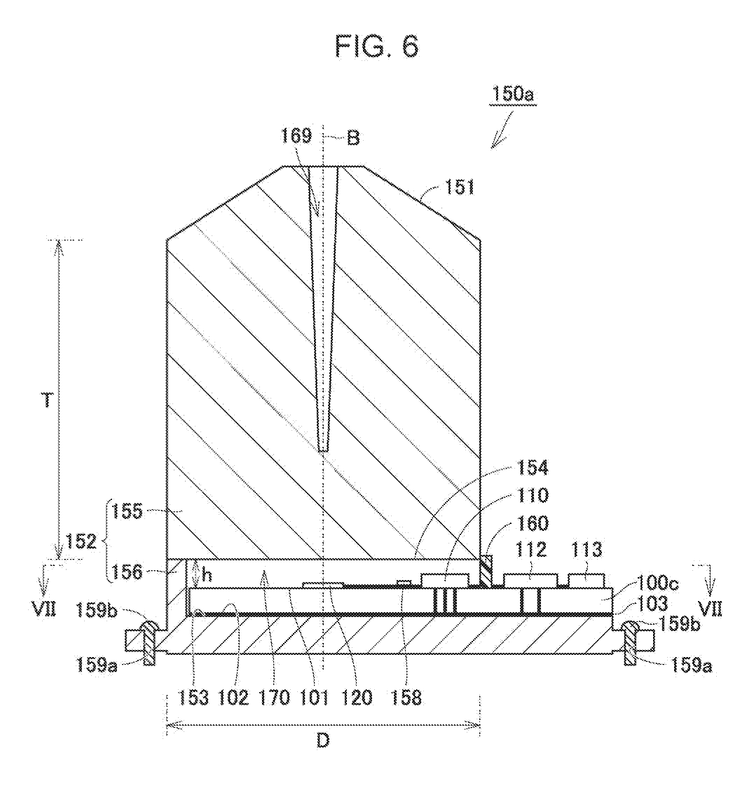

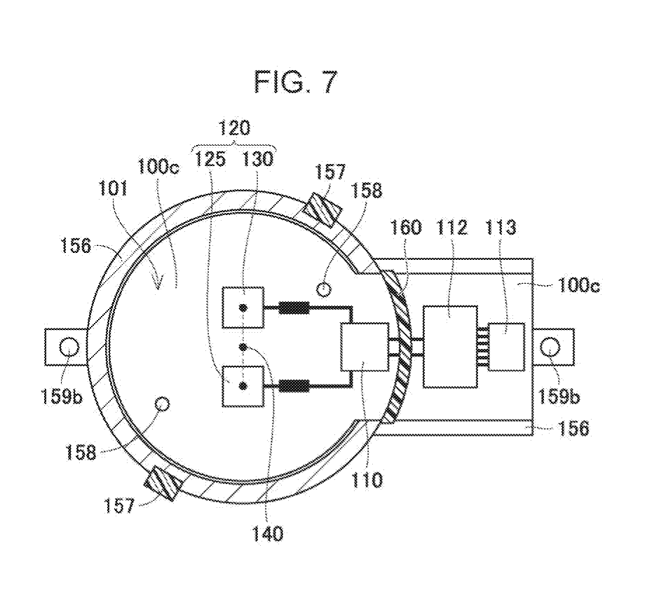

FIG. 6 is a sectional view showing a configuration of a high-frequency apparatus according to a first modification example of Embodiment 1 of the present disclosure. FIG. 7 is a sectional view of the high-frequency apparatus of FIG. 6, as viewed from a direction of the arrow VII-VII. In the present modification example, a circuit substrate 100c has a substantially circular portion along the inner shape of the accommodation chamber 170 and a rectangular shape extending outward from the accommodation chamber 170, as viewed from a direction perpendicular to the first main surface 101.

Next, a second modification example of Embodiment 1 of the present disclosure will be described. Since the second modification example of Embodiment 1 of the present disclosure is different from the high-frequency apparatus 150a according to Embodiment 1 in that a metal plate is further provided, the description of the same configuration as that of the high-frequency apparatus 150a according to Embodiment 1 will not be repeated.

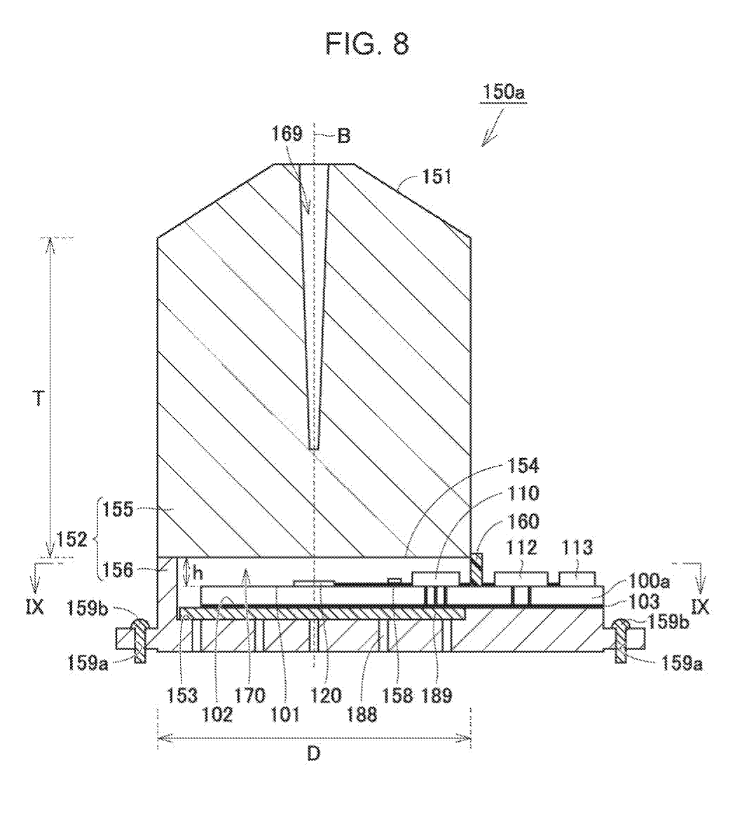

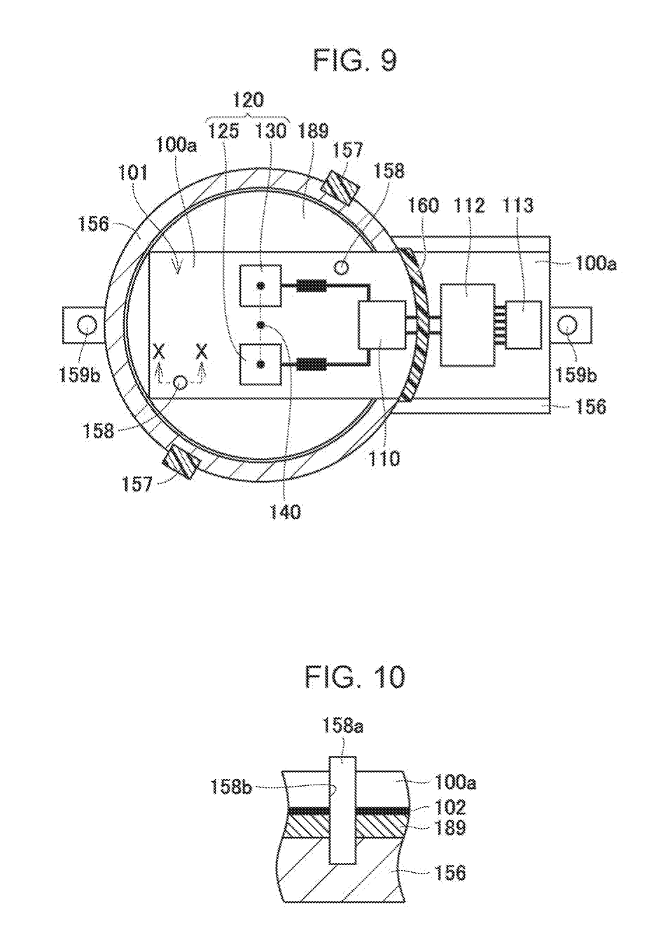

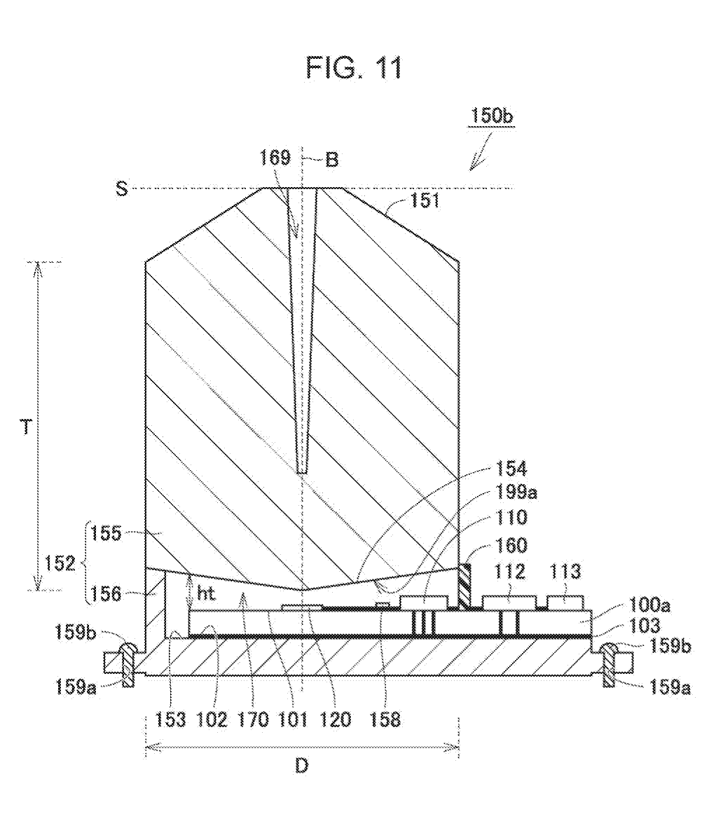

FIG. 8 is a sectional view showing a configuration of a high-frequency apparatus according to the second modification example of Embodiment 1 of the present disclosure. FIG. 9 is a sectional view of the high-frequency apparatus of FIG. 8, as viewed from the direction of the arrow IX-IX. FIG. 10 is an enlarged sectional view of a part of the high-frequency apparatus of FIG. 9, as viewed from the direction of the arrow X-X.

In the present modification example, as shown in FIGS. 8 and 9, the high-frequency apparatus 150a further includes a substantially circular metal plate 189 along the inner shape of the accommodation chamber 170. The metal plate 189 is provided between the second main surface 102 of the circuit substrate 100a and the first inner surface portion 153 of the dielectric block 152. The metal plate 189 is a ground plate that functions as a ground surface of the circuit substrate 100a by coming into contact with the second main surface 102.

In the present modification example, the high-frequency apparatus 150a further includes a through hole 188. As shown in FIG. 8, the through hole 188 is formed in the second dielectric portion 156 so as to penetrate the second dielectric portion 156 from the end surface on the side opposite to the accommodation chamber 170 side to the first inner surface portion 153. Since the through hole 188 functions as a heat dissipation hole, the high-frequency apparatus 150a according to the present modification example is excellent in temperature characteristics, and more stable antenna characteristics and high-frequency characteristics may be secured.

As described above, in the high-frequency apparatus 150a according to Embodiment 1, the dielectric block 152 is provided with the accommodation chamber 170 for accommodating the circuit substrate 100a, and the accommodation chamber 170 has the first inner surface portion 153 which is in contact with the second main surface 102 and to which the circuit substrate 100a is fixed. That is, the whole or a part of the circuit substrate 100a is configured to be inserted and fixed in the accommodation chamber 170. Therefore, since a supporting base such as a holder for supporting the circuit substrate 100a and the dielectric block 152 is unnecessary, the high-frequency apparatus 150a may be easily assembled, compact and inexpensive.

Further, since the first dielectric portion 155 and the second dielectric portion 156 are connected to each other by the connecting portion 157, the dielectric block 152 may be configured as a two-piece combined component, and the circuit substrate 100a may be disposed on the dielectric block 152 to facilitate fixing. In addition, the dielectric block 152 may configured by fitting the first dielectric portion 155 and the second dielectric portion 156 or by connecting the first dielectric portion 155 and the second dielectric portion 156 by the connecting portion 157 such as a screw and fixing the first dielectric portion 155 and the second dielectric portion 156 to each other. Therefore, when the high-frequency apparatus 150a is mass-produced, the dielectric block 152 itself may be produced with a metal mold, and the high-frequency apparatus 150a may be manufactured by a simple process. As a result, a supporting base for supporting the circuit substrate 100a and the dielectric block 152 is unnecessary and mass productivity of the high-frequency apparatus 150a may be improved, and since there is no need for a supporting base that needs to be produced by using a metal mold in addition to the first dielectric portion 155 and the second dielectric portion 156, the high-frequency apparatus 150a may be made into a simple, low cost, compact size.

Further, since the shortest distance between the second inner surface portion 154 and the planar antenna unit 120 is 1 mm or more and λ/2 or less, that is, in the accommodation chamber 170 in the dielectric block 152, a space of at least 1 mm to λ/2 (λ: operating wavelength) is provided between the planar antenna unit 120 and the first dielectric portion 155, impedance matching between the planar antenna unit 120 and the dielectric block 152 is facilitated. As a result, since coupling between the dielectric block 152 and the planar antenna unit 120 is facilitated and unnecessary loss is less likely to occur, in the high-frequency apparatus 150a according to Embodiment 1 of the present disclosure, the radiation efficiency of the antenna is high.

In addition, since the space of 1 mm to λ/2 or less is provided in the dielectric block 152, the space may be enclosed not only in the planar antenna unit 120 but also in the IC, that is, in each integrated circuit module, in the dielectric block 152. Therefore, the dielectric block 152 may be configured as a lid body or a casing of the circuit module, and the high-frequency apparatus 150a may be configured to be more compact at low cost.

Further, since the central portion of the planar antenna unit 120 is located on the central axis B of the first dielectric portion 155, the radiation beam may be directed in the front direction.

Further, the first dielectric portion 155 has a frustum-shaped portion 151 on the side opposite to the accommodation chamber 170 side. In a case where the frustum-shaped portion 151 is not provided on the opposite side of the first dielectric portion 155 from the accommodation chamber 170 side, the propagation path of radio waves directly propagating from the planar antenna unit 120 through the periphery of the central axis B of the dielectric block 152 to the plane S and not reflected on the side surface of the dielectric block 152 is shorter than that of radio waves propagating by reflection on the side surface of the dielectric block 152, and the phase advances.

Therefore, in the high-frequency apparatus 150a according to the present embodiment, it is possible to easily adjust the phase of radio waves propagating inside the dielectric block 152 and the outer periphery of the dielectric block 152 on the plane S parallel to the front end surface of the dielectric block 152 by having a frustum-shaped portion on the opposite side of the first dielectric portion 155 of the dielectric block 152 from the accommodation chamber 170 side.

### Embodiment 2

Hereinafter, a high-frequency apparatus according to Embodiment 2 of the present disclosure will be described. Since the shape of the second inner surface portion 154 of the high-frequency apparatus according to Embodiment 2 of the present disclosure is different from the high-frequency apparatus 150a according to Embodiment 1 of the present disclosure, the description of the same configuration as that of the high-frequency apparatus 150a according to Embodiment 1 of the present disclosure will not be repeated.

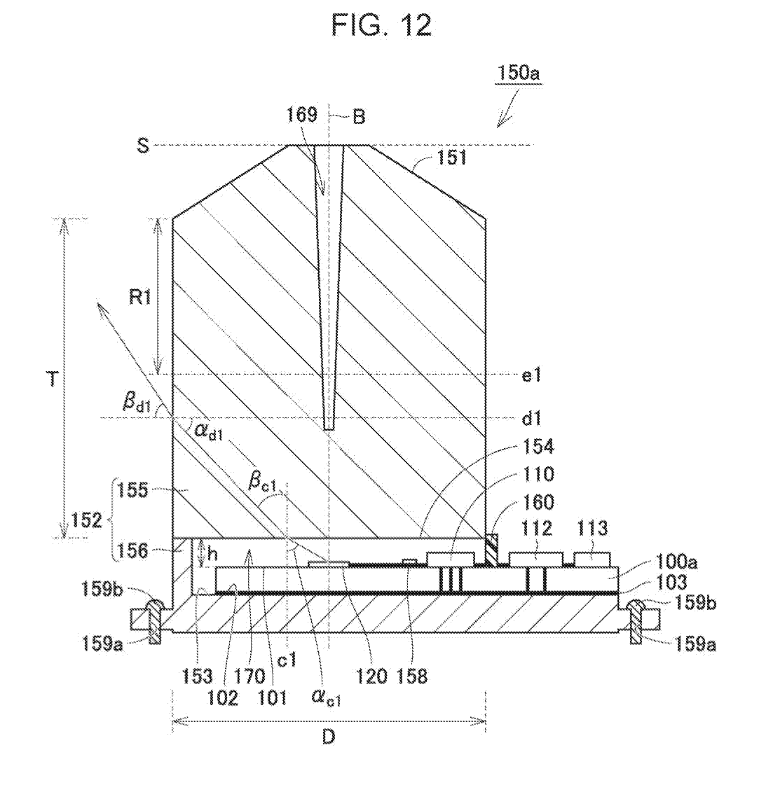

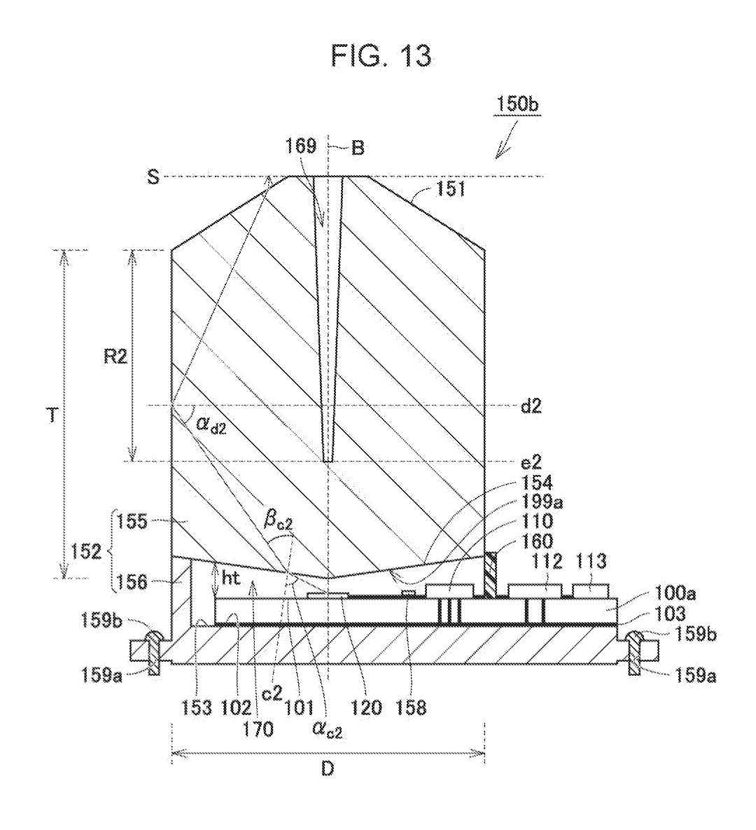

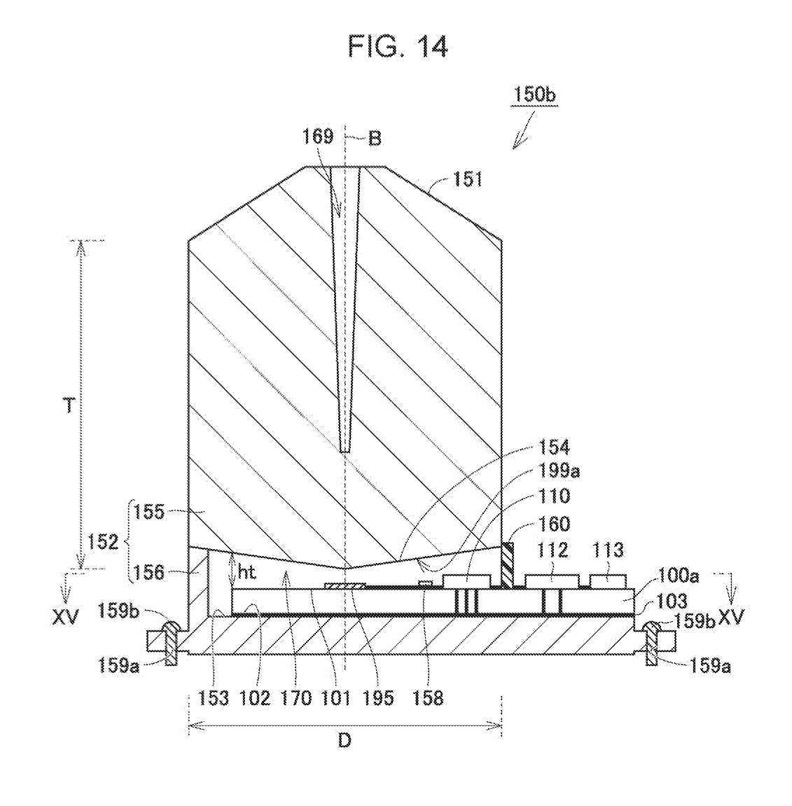

FIG. 11 is a sectional view showing a configuration of a high-frequency apparatus according to Embodiment 2 of the present disclosure. FIG. 12 is a schematic view showing paths of radio waves transmitting through a side surface of the dielectric block included in the high-frequency apparatus according to Embodiment 1 of the present disclosure. FIG. 13 is a schematic view showing paths of radio waves that are reflected by a side surface of a dielectric block included in the high-frequency apparatus according to Embodiment 2 of the present disclosure.

The second inner surface portion 154 has a convex tapered shape 199a or a curved surface shape on the planar antenna unit 120 side. As shown in FIG. 11, in the present embodiment, the second inner surface portion 154 has the convex tapered shape 199a on the planar antenna unit 120 side. Since the second inner surface portion 154 has the convex tapered shape 199a or a curved surface shape, the outer shape of the accommodation chamber 170 on the first dielectric portion 155 side in the present embodiment is the same as the outer shape of the accommodation chamber 170 on the first dielectric portion 155 side in Embodiment 1. The apex portion of the tapered shape 199a or the curved surface shape is located on the central axis B.

The length of a maximum gap ht from the circuit substrate 100a to the second inner surface portion 154 having the convex tapered shape 199a or a curved surface shape, the taper angle of the convex taper shape 199a, and the curvature of the curved surface shape are appropriately adjusted according to the material of the circuit substrate 100a and the size of the first dielectric portion 155.

Next, with reference to FIGS. 12 and 13, the differences in the paths of radio waves between Embodiment 1 and Embodiment 2 will be described. In Embodiment 1, in a case where radio waves are incident on the side surface of the dielectric block 152 on the plane S side than a plane el shown in FIG. 12, no refraction wave occurs and total reflection occurs. In Embodiment 1, as described above, a region in the side surface portion of the dielectric block 152 where total reflection of radio waves radiated from the planar antenna unit 120 occurs is referred to as a side surface portion R1.

Then, as shown in FIG. 12, in the high-frequency apparatus 150a according to Embodiment 1, radio waves radiated from the planar antenna unit 120 at an angle travel through the dielectric block 152 and then are incident on a portion of the side surface of the dielectric block 152 that intersects with a plane d1. Since the plane d1 is located closer to the second inner surface portion 154 side than the side surface portion R1, the radio waves incident on a portion of the side surface of the dielectric block 152 that intersects with the plane dl transmit through the side surface of the dielectric block 152 and generate refracted waves.

It is assumed that the normal line of the second inner surface portion 154 is c1 at the portion where the radio wave is incident on the second inner surface portion 154 of the dielectric block 152 and when the radio wave is incident on the second inner surface portion 154, the incident angle is α_{c1} and the refraction angle is β_{c1}. In addition, when the radio waves are incident on the side surface of the dielectric block 152, it is assumed that the incident angle is α_{d1} and the refraction angle is β_{d1}. Since the radio waves are incident on the dielectric block 152 having a higher dielectric constant than that in the air on the normal line c1, β_{c1}<α_{c1}.

On the other hand, as shown in FIG. 13, in the high-frequency apparatus 150b according to Embodiment 2, radio waves radiated from the planar antenna unit 120 at the same angle as the radio waves shown in FIG. 12 are totally reflected when the radio waves are incident on the side surface of the dielectric block 152.

In the high-frequency apparatus 150b, it is assumed that the normal line of the second inner surface portion 154 is c2 at the portion where the radio wave is incident on the second inner surface portion 154 of the dielectric block 152 and when the radio wave is incident on the second inner surface portion 154, the incidence angle is α_{c2} and the refraction angle is β_{c2}. Since the radio waves are incident on the dielectric block 152 having a higher dielectric constant than that in the air on the normal line c2, β_{c2}<α_{c2}.

When comparing the inclination of the normal line c1 and the inclination of the normal line c2 with respect to the first main surface 101 of the circuit substrate 100a on which the planar antenna unit 120 is provided, the inclination of the normal line c2 is the normal line c1. Since the inclination of the normal line c2 is larger than the inclination of the normal line c1, in the present embodiment, radio waves passing through the inside of the dielectric block 152 travels further inside the dielectric block 152 compared with the high-frequency apparatus 150a according to Embodiment 1.

Then, as shown in FIG. 13, the radio waves of the present embodiment are incident on a portion of the side surface of the dielectric block 152 that intersects with a plane d2. The plane d2 in the present embodiment is located closer to the plane S than the plane d1 in Embodiment 1.

Accordingly, since the second inner surface portion 154 has the convex tapered shape 199a or a curved surface shape on the side of the planar antenna unit 120 and radio waves radiated from the planar antenna unit 120 are incident on the side surface of the dielectric block 152 at a position closer to the plane S, it is possible to increase the incident angle of the radio waves to the side surface of the dielectric block 152 and to further increase the proportion of radio waves to be plane waves in the plane S.

Further, in the present embodiment, the region of the side surface portion of the dielectric block 152 where the total reflection of radio waves radiated from the planar antenna unit 120 occurs is a side surface portion R2 as shown in FIG. 13. The length of the side surface portion R2 is longer than the length of the side surface portion R1 of Embodiment 1. This is because the incident angle of radio waves incident on a certain position on the side surface of the dielectric block 152 in the high-frequency apparatus 150b according to the present embodiment is larger than the incident angle of radio waves incident on the same position on the side surface of the dielectric block 152 in Embodiment 1. From this also, in the present embodiment, it is possible to further increase the proportion of radio waves to be plane waves in the plane S.

In addition, since the second inner surface portion 154 has the convex tapered shape 199a or a curved surface shape on the planar antenna unit 120 side, it is possible to reduce the proportion of radio waves perpendicularly incident on the surface constituting the second inner surface portion 154 among the radio waves radiated from the planar antenna unit 120. Therefore, impedance matching between the dielectric block 152 and the planar antenna unit 120 is facilitated, the proportion of transmitted waves (refracted waves) that are incident to the dielectric block 152 may be increased, and the propagation efficiency of radio waves becomes high.

As described above, a part of radio waves traveling from the planar antenna unit 120 toward the side surface of the first dielectric portion 155 having a columnar outer shape is reflected by this side surface, and the other part of the radio waves is transmitted through the air and refracted. When the incident angle of radio waves incident on the side surface of the dielectric block 152 from the dielectric block 152 side is large, no refraction wave is generated in the air, and radio waves may not be refracted and total reflection sometimes occurs. The smallest angle among the incident angles in such a case is a critical angle. As an example, in a case where the dielectric block 152 is made of polypropylene having a relative dielectric constant of 2.3, when radio waves are transmitted and refracted from the side of the dielectric block 152 into the air, the phase velocity of the air is high and the refraction angle is larger than the incident angle (=reflection angle), and therefore there is a critical angle.

In order to increase the antenna gain as the dielectric antenna, that is, to narrow down the main beam of the antenna, it is necessary to perform in-phase combining on the front end surface of the dielectric block 152 so that the waves around the first dielectric portion 155 and the first dielectric portion 155 become plane waves. For this purpose, it is preferable to increase the incident angle to the side surface of the dielectric block 152 to widen the region where total reflection occurs so that radio waves are not transmitted and refracted from the side surface of the dielectric block 152 to the outside. Therefore, by forming the second inner surface portion 154, which is the upper surface of the accommodation chamber 170 of the dielectric block 152, to have the tapered shape 199a protruding downward from the central axis of the dielectric block 152 or a curved surface shape, the angle of incidence on the side surface of the dielectric block 152 is increased, and the region of total reflection may be widened. Consequently, at the tip of the dielectric block 152, the radio waves may be made more planar, the gain of the antenna may be increased and the beam width may be narrowed.

### Embodiment 3

Hereinafter, a high-frequency apparatus according to Embodiment 3 of the present disclosure will be described. Since the high-frequency apparatus according to Embodiment 3 of the present disclosure is different from the high-frequency apparatus 150b according to Embodiment 2 mainly in that the planar antenna unit 120 is configured with one transmit/receive antenna, the description of the same configuration as that of the high-frequency apparatus 150b according to Embodiment 2 will not be repeated.

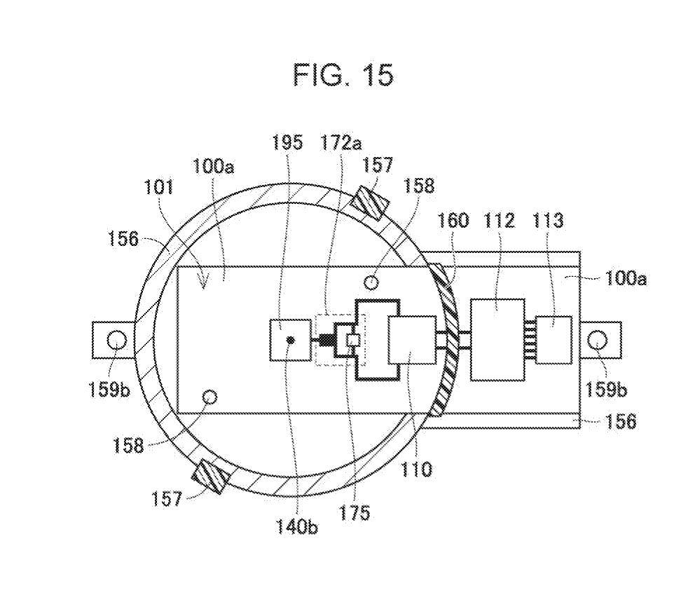

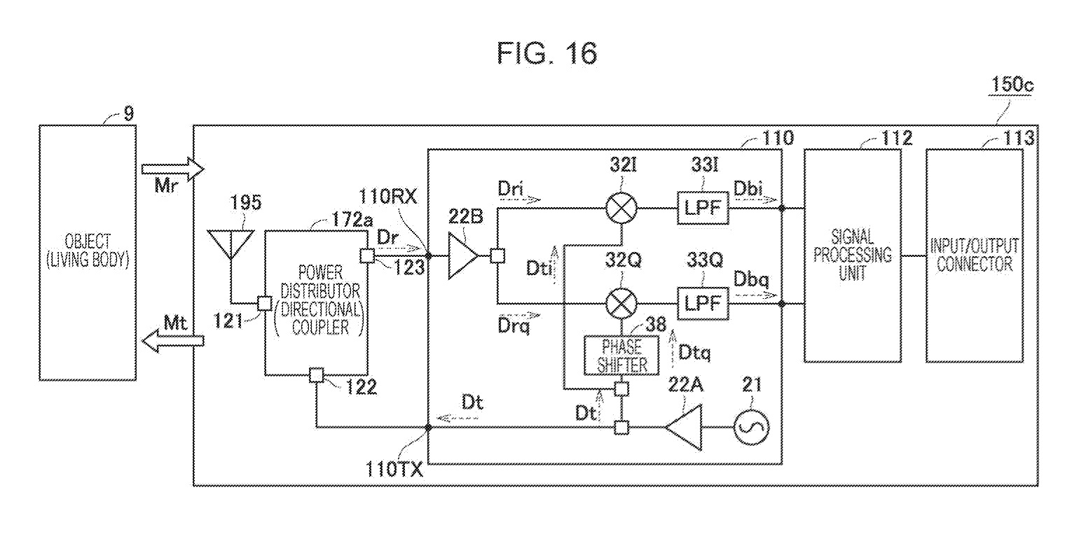

FIG. 14 is a sectional view showing a configuration of a high-frequency apparatus according to Embodiment 3 of the present disclosure. FIG. 15 is a sectional view of the high-frequency apparatus cf FIG. 14, as viewed in the direction of the arrow XV-XV. FIG. 16 is a block view showing a circuit configuration of the high-frequency apparatus according to Embodiment 3 of the present disclosure.

As shown in FIGS. 14 to 16, the planar antenna unit in the present embodiment includes one transmit/receive antenna 195, and the transmit/receive antenna 195 includes a power supply unit 121. The transmit/receive antenna 195 is a single-element microstrip patch antenna and has functions of the transmit antenna unit 125 and the receive antenna unit 130 in Embodiment 1.

As shown in FIG. 14, the transmit/receive antenna 195 is provided on the circuit substrate 100a. As shown in FIG. 15, the central portion of the planar antenna unit in the present embodiment is a center point 140b of the transmit/receive antenna 195. The center point 140b is located on the central axis B of the first dielectric portion 155 shown in FIG. 14.

As shown in FIG. 16, the high-frequency circuit unit 110 in the present embodiment includes a transmission-side output terminal 110TX as a transmission terminal and a reception-side input terminal 110RX as a reception terminal.

The power supply unit 121 and each of the transmission-side output terminal 110TX and the reception-side input terminal 110RX are connected to each other via a power distributor 172a such as a Wilkinson-type power distributor having terminal-to-terminal isolation or a bifurcated coupler having directivity, for example, a branch line coupler or the like. Specifically, the transmission-side output terminal 110TX is electrically connected to the power distributor 172a or the transmission terminal 122 of the bifurcated coupler. The reception-side input terminal 110RX is electrically connected to the power distributor 172a or a reception terminal 123 of the bifurcated coupler. By being connected in this manner, a high-frequency apparatus 150c in the present embodiment may function as the transmit/receive antenna 195 with one antenna element.

In the present embodiment, the power supply unit 121, and each of the transmission-side output terminal 110TX and the reception-side input terminal 110RX are electrically connected to each other via the power distributor 172a having terminal-to-terminal isolation. The power distributor 172a has transmission/reception isolation characteristics, and the power distributor 172a has an absorption resistance 175 of about 100 Ω.

Hereinafter, the operation of the high-frequency apparatus 150c will be described with reference to FIG. 16. By connecting each of the transmission-side output terminal 110TX and the reception-side input terminal 110RX, and the power supply unit 121 to each other via the power distributor 172a or a bi-directional distributor having directivity, the transmission signal Dt and the reception signal Dr are separated by this isolation characteristics and the leak components to the reception terminal 123 side of the transmission signal Dt are reduced, and therefore distortion of the amplifier 22B which is a low noise amplifier may be removed.

Here, the power distributor 172a and the bifurcated distributor may also operate as a Wilkinson-type power combiner and a branch line coupler, respectively. Therefore, as a power coupler (coupler) at the time of transmission, the transmission signal Dt output from the transmission-side output terminal 110TX of the high-frequency circuit unit 110 is input to the coupler by the transmission terminal 122, is supplied to the transmission antenna unit via the power supply unit 121, and the microwave Mt is emitted.

On the other hand, when a microwave Mr received at the transmit/receive antenna 195 is input to the power supply unit 121, the power distributor 172a having terminal-to-terminal isolation or the bifurcated coupler having directivity operates as a power distributor that outputs reception signals to the reception terminal 123 and the transmission terminal 122. The reception signal Dr from the reception terminal 123 is input to the amplifier 22B from the reception-side input terminal 110RX of the high-frequency circuit unit 110 and amplified. On the other hand, the transmission signal Dt output to the transmission terminal 122 is terminated by the amplifier 22A.

As in Embodiment 1 or 2, in a case where the planar antenna unit 120 includes the transmit antenna unit 125 which is a planar antenna of one element and the receive antenna unit 130 which is a planar antenna of one element, and the antenna gain is increased by using one dielectric block 152 (when narrowing beam width), since the transmit antenna unit 125 and the receive antenna unit 130 are independent from each other, it is difficult to completely match the center of each of the transmit antenna unit 125 and the receive antenna unit 130 with the central axis of the dielectric block 152. On the other hand, as in the present embodiment, it is possible to match the central portion of one element transmit/receive antenna 195 with the central axis of the dielectric block 152 by configuring the planar antenna unit with the transmit/receive antenna 195 which is one element of a radiation element unit, with one dielectric block 152. By matching the radiation axis of the antenna with the central axis of the dielectric block 152 in this way, the beam direction of the antenna does not deviate and the antenna gain may be further increased.

In addition, since the high-frequency apparatus 150c may be operated by one transmit/receive antenna 195, a more compact circuit may be configured, and further the high-frequency apparatus 150c may be made smaller and simpler.

### Embodiment 4

Hereinafter, a high-frequency apparatus according to Embodiment 4 of the present disclosure will be described. The high-frequency apparatus according to Embodiment 4 of the present disclosure functions as a person detecting sensor that detects movement of a person and has the same configuration as that of any one of the high-frequency apparatuses of Embodiments 1 to 3.

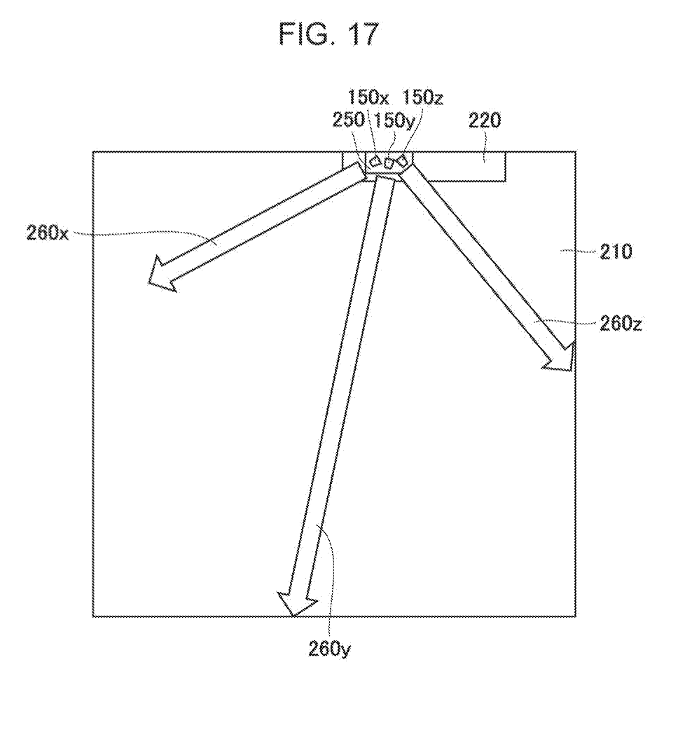

FIG. 17 is a schematic view showing a closed space in which an apparatus including a plurality of high-frequency apparatuses according to Embodiment 4 of the present disclosure is installed.

High-frequency apparatuses 150x, 150y, and 150z according to the present embodiment function as a person detecting sensor 250 that detects a movement of a person. As shown in FIG. 17, in the present embodiment, the high-frequency apparatuses 150x, 150y, and 150z are incorporated in a device 220 (for example, an air conditioner) disposed in a closed space 210 (for example, a living room).

In order to function as the person detecting sensor 250, the high-frequency apparatuses 150x, 150y, and 150z are arranged in directions with different azimuth angles at intervals of 60 degrees and are operating at different operating frequencies at all times. It is possible to detect in which direction, how far the person is and how much the person is moving by constantly monitoring the strengths of radio waves 260x, 260y, and 260z from the high-frequency apparatuses 150x, 150y, and 150z and the magnitude of the Doppler shift to reconstruct the information in the three types of areas.

The elevation angle directions of the high-frequency apparatuses 150x, 150y, and 150z are appropriately set according to the size of the room so as to function as the person detecting sensor 250, and in the present embodiment, in a case where the closed space 210 has an area of 18 tatami mats, the respective elevation angle directions are set to about 30 degrees downward.

As a modification example of the present embodiment, one high-frequency apparatus 150x may function as the person detecting sensor 250 that scans at a reciprocating angle of 180 degrees in the azimuth direction. In the present modification example, the high-frequency apparatus 150x constantly scans at a reciprocating angle of 180 degrees and monitors the strengths of the radio waves and the magnitude of the Doppler shift during operation of the device 220 (for example, an air conditioner). With this, it is possible to more accurately detect in which direction, how far the person is and how much the person is moving.

According to the present embodiment, the radio waves radiated from the planar antenna unit 120 are in-phase to be plane waves, and the high-frequency apparatuses 150x, 150z, and 150z have excellent long-range characteristics because the side lobes are reduced, the surrounding unnecessary waves are not easily picked up, and the main beam has more narrowed antenna radiation characteristics. Therefore, the high-frequency apparatus may function as a person detecting sensor that detects movement of a person by further including the signal processing unit 112 connected to the high-frequency circuit unit 110 and the input/output connector 113 connected to the signal processing unit 112. The high-frequency apparatus according to the above embodiment may function as the person detecting sensor 250 that detects the movement of a person in a room, specifically by attaching at least one or a plurality of the high-frequency apparatuses to the ceiling, the wall, the inside or the periphery of a lighting device, or the inside or the periphery of an air conditioner.

In addition, according to the present embodiment, since the circuit substrate 100a on which the planar antenna unit and the high-frequency circuit unit 110 are provided is disposed in the dielectric block 152, screw holes and the like may be formed in the bottom surface of the dielectric block. Therefore, it is possible to arrange a single or a plurality of high-frequency apparatuses in one casing, and further it is possible to easily attach the high-frequency apparatus to the ceiling, the wall, the inside or the periphery of the lighting device, or the inside or the periphery of the air conditioner in order to make the apparatus function as the person detecting sensor 250.

In addition, according to the present embodiment, since it is unnecessary to attach radiation windows together with the high-frequency apparatuses 150x, 150y, and 150z, it is possible to install the high-frequency apparatuses 150x, 150y, and 150z without making the apparatuses stand out. In addition, the beam may be narrowed down as a dielectric antenna, for example, the high-frequency apparatuses 150x, 150y, and 150z may function as a monitoring apparatus, that is, a vital sensor of movement of the body, heartbeat or breathing of the subject by installing the high-frequency apparatuses 150x, 150y, and 150z on the ceiling or the like.

In addition, according to the present embodiment, in a case where the high-frequency apparatuses 150x, 150y, and 150z are attached to the lighting device, for example, since the dielectric block is made of polycarbonate or the like, the high-frequency apparatuses 150x, 150y, and 150z are configured as dielectric antennas having transparent dielectric blocks, the apparatuses block the light emitted by the lighting device and do not make shadows. Therefore, the high-frequency apparatuses 150x, 150y, and 150z may function as the person detecting sensor 250 without sacrificing the performance of the lighting apparatus.

The above-described embodiment disclosed this time is an example in all respects and is not a basis for restrictive interpretation. Therefore, the technical scope of the present disclosure is not interpreted only by the above-described embodiment, but is defined based on the description of claims. In addition, the meanings equivalent to the claims and all changes within the scope are included.

The present disclosure contains subject matter related to that disclosed in Japanese Priority Patent Application JP 2018-082439 filed in the Japan Patent Office on Apr. 23, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A high-frequency apparatus comprising:
a circuit substrate that includes a first main surface and a second main surface;
a planar antenna unit that is provided on the first main surface;
a high-frequency circuit unit that is provided on the first main surface and connected to the planar antenna unit; and
a dielectric block that is provided with an accommodation chamber for accommodating the circuit substrate, wherein
the accommodation chamber includes
a first inner surface portion that is in contact with the second main surface and to which the circuit substrate is fixed, and
a second inner surface portion that opposes the planar antenna unit with a space therebetween, the dielectric block includes
a first dielectric portion that is located on a side of the second inner surface portion opposite to a side of the accommodation chamber, and
a second dielectric portion that is located on the side of the accommodation chamber of the second inner surface portion,
the first dielectric portion has a columnar outer shape, and
when an operating wavelength of the planar antenna unit is λ, a dimension of a maximum width of the first dielectric portion in a section substantially parallel to the first main surface is λ or more.

2. The high-frequency apparatus according to claim 1,
wherein the first dielectric portion and the second dielectric portion are connected to each other by a connecting portion.

3. The high-frequency apparatus according to claim 1,
wherein the shortest distance between the second inner surface portion and the planar antenna unit is 1 mm or more and λ/2 or less.

4. The high-frequency apparatus according to claim 1,
wherein a central portion of the planar antenna unit is located on a central axis of the first dielectric portion.

5. The high-frequency apparatus according to claim 1,
wherein the first dielectric portion includes a frustum-shaped portion on a side opposite to a side of the accommodation chamber.

6. The high-frequency apparatus according to claim 1,
wherein the second inner surface portion has a convex tapered shape or a curved surface shape on a side of the planar antenna unit.

7. The high-frequency apparatus according to claim 1, wherein
the planar antenna unit includes one transmit/receive antenna,
the transmit/receive antenna includes a power supply unit,
the high-frequency circuit unit includes a transmission terminal and a reception terminal, and
the power supply unit and, each of the transmission terminal and the reception terminal are connected to each other via a power distributor having terminal-to-terminal isolation or a bifurcated coupler having directivity.

8. The high-frequency apparatus according to claim 1, further comprising:
a signal processing unit that is connected to the high-frequency circuit unit; and
an input/output connector that is connected to the signal processing unit, wherein
the apparatus functions as a person detecting sensor that detects movement of a person.
